(19) United States
(12) Patent Application Publication
(10) Pub. No.: US 2015/0185152 A1
(43) Pub. Date: Jul. 2, 2015

(54) Illumination Systems

(71) Applicant: LIFE TECHNOLOGIES CORPORATION, Carlsbad, CA (US)

(72) Inventor: Kevin Maher, Woodside, CA (US)

(21) Appl. No.: 14/420,647

(22) PCT Filed: Aug. 9, 2013
(86) PCT No.: PCT/US2013/054413

§ 371 Date: Feb. 9, 2015

Related U.S. Application Data
(60) Provisional application No. 61/681,538, filed on Aug. 9, 2012.

(51) Int. Cl. G01N 21/64

(52) U.S. Cl. CPC G01N 21/6486; G01N 2201/0446; G01N 2201/062

(57) ABSTRACT

A system for detecting emissions from a sample containing nucleotide molecules contains a sample holder, an optical illumination system, an optical sensor. The sample holder includes a plurality of spatially separated reaction sites configured to hold a sample containing nucleotide molecules. The optical illumination system comprising a radiant source configured to simultaneously illuminate two or more of the reaction sites. The illumination system includes a homogenizer. An output from the homogenizer has less variation in power, energy, irradiance, or intensity than the variation in power, energy, irradiance, or intensity of the source.

### BACKGROUND OF THE INVENTION

1. Field of the Invention

The present invention relates generally to devices, instruments, systems, and methods for monitoring or measuring a plurality of biological reactions, and more specifically to devices, instruments, systems, and methods for optically monitoring or measuring a plurality of biological reactions with a radiant or light source.

2. Description of the Related Art

Optical systems have been used to monitor, measure, and/or analyze for biological and biochemical reactions. Such systems are commonly used in sequencing, genotyping, amplification processes such as polymerase chain reactions (PCR), and other biochemical reactions to monitor progress of reactions and provide quantitative data. For example, an optical excitation beam may be used during real-time PCR (qPCR) processes to illuminate fluorescent DNA-binding dyes or fluorescent probes to produce fluorescent signals indicative of the amount of a target gene or other nucleotide sequence. Increasing demands to provide greater numbers of reactions per test or experiment have resulted in instruments that are able to conduct large numbers of reactions simultaneously.

When illuminating a number of biological reactions simultaneously for optical measurement or monitoring, it may be desirable to condition radiant energy or light from a source so that the available energy or power is efficiently utilized and evenly illuminates the samples involved. For example, light emitting diodes (LEDs) are currently used for their availability at high powers and a wide variety of spectral characteristics. However, LEDs may have a large divergence angle and uneven illumination characteristics. It is, therefore, desirable to provide optical systems for biological and biochemistry applications that provide efficient and/or even illumination over the extended area of a plurality of biological samples.

### BRIEF DESCRIPTION OF THE DRAWINGS

Embodiments of the present invention may be better understood from the following detailed description when read in conjunction with the accompanying drawings. Such embodiments, which are for illustrative purposes only, depict novel and non-obvious aspects of the invention. The drawings include the following figures:

FIG. 1 is a schematic diagram of a system according to an embodiment of the present invention.

FIG. 2 is a schematic diagram of a system according to another embodiment of the present invention.

FIG. 3 is a front view of a radiant source according to an embodiment of the present invention.

FIG. 4 is a side view of a system according to an embodiment of the present invention.

FIG. 5 is a side view of a system according to another embodiment of the present invention.

FIG. 6 is a side view of a homogenizer and radiant source of the system shown in FIG. 5 with a lenslet array not shown for clarity.

FIG. 7 is a side view of a homogenizer and radiant source of the system shown in FIG. 5.

FIG. 8 is a side view of a homogenizer and radiant source according to another embodiment of the system shown in FIG. 5.

FIG. 9 is a plot of an output from a radiant source and into a homogenizer according to embodiments of the present invention.

FIG. 10 is a plot of an output from the system and homogenizer shown in FIG. 4 for the input shown in FIG. 9

FIG. 11 is a plot of the irradiance at an image plane located at or near the face of a sample holder for the system and homogenizer shown in FIG. 4.

FIG. 12 is a system according to an embodiment of the present invention.

### DETAILED DESCRIPTION OF THE DRAWINGS

Embodiments of the present invention are generally directed to devices, instruments, systems, and methods for monitoring or measuring biological reactions occurring in an array or system of biological samples. More specifically, embodiments of the present invention include devices, instruments, systems, and methods for providing a predetermined distribution of electromagnetic radiation or light over an array or system of biological samples.

In various embodiments, the devices, instruments, systems, and methods described herein may be used to detect, monitor, or measure one or more types of biological components of interest contained in a sample or solution containing one or more target biological components of interest. These biological components may be any suitable biological target including, but are not limited to, DNA sequences (including cell-free DNA), RNA sequences, genes, oligonucleotides, molecules, proteins, biomarkers, cells (e.g., circulating tumor cells), or any other suitable target biomolecule. In various embodiments, such biological components may be used in conjunction a sequencing and/or DNA amplification process, system, or instrument. Embodiments of the present invention include the use of a polymerase chain reaction (PCR) processes or protocols, which may include, without limitation, allele-specific PCR, asymmetric PCR, ligation-mediated PCR, multiplex PCR, nested PCR, real-time PCR (qPCR), genome walking, bridge PCR, digital PCR (dPCR), or the like. In various embodiments, the biological components may be used in applications such as fetal diagnostics, multiplex dPCR, viral detection and quantification standards, genotyping, sequencing validation, mutation detection, detection of genetically modified organisms, rare allele detection, copy number variation, and the like.

As used herein, the terms “biological sample”, “biochemical sample”, or “sample” means any specimen or solution containing materials associated with processes within, or in support of, biological organisms or agents such as eukaryotes (e.g., plant or animal), prokaryotes (e.g., bacteria, archaea), viruses, or the like. Such materials may include, but are not limited to, cells, tissues, organs, and biochemical substances such as polynucleotides, DNA molecules, RNA molecules, polypeptides, proteins, and the like.

As used herein, the term “radiant source” refers to a source of electromagnetic radiation, for example, a source of electromagnetic radiation that is within one or more of the visible, near infrared, infrared, or ultraviolet wavelength bands of the electromagnetic spectrum. As used herein, the term “light source” refers to a source of electromagnetic radiation comprising a spectrum comprising a peak or maximum output (e.g., power, energy, or intensity) that is within the visible band of the electromagnetic spectrum.

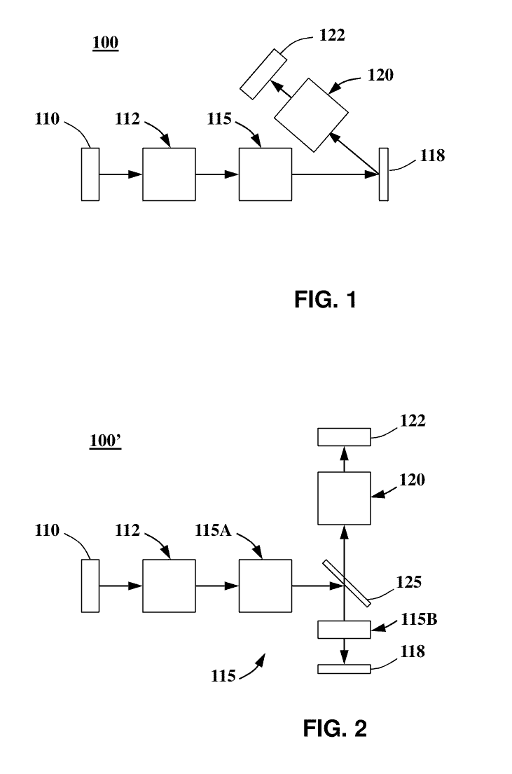

Referring to FIG. 1, in certain embodiments, an instrument or system 100 comprises a radiant or light source 110 that may be used to excite dyes, molecular probes, molecular beacons, or the like contained an array of biological or biochemical samples. System 100 also compromises a homogenizer 112, imaging and/or conditioning optic(s) 115, and a sample holder or carrier 118 comprising an array of biological or biochemical samples. Radiant or light source 110 may produce one or more excitation beams or sources that illuminate biological samples located within or on sample holder 118. System 100 further comprises an imaging system or optics 120 for directing optical emissions from the samples of sample holder 118 to an optical sensor 122. For example, the biological samples of sample holder 118 may produce a luminescent or fluorescent signal or emission in response to illumination by source 110 that is indicative of, or proportional to, an absolute or relative amount or concentration of a target biochemical such as a target nucleic acid or polynucleotide. In the illustrated embodiment, emissions from sample holder 118 are emitted and detected from the same side of the array as the excitation beam from source 110. Additionally or alternatively, emissions from sample holder 118 may be emitted and detected from a side opposite the side from which sample holder 118 is illuminated by source 110.

Optics 115 or 120 may include one or more windows, refractive lenses, gratings, prisms, diffractive optical elements, minors, beamsplitters, filters, or the like, either alone or in combination. Filters may be located in an excitation beam path and/or the emission beam path, and may include neutral density filters, spectral filters (e.g., high pass, low pass, bandpass, notch, interference, dichroic, multi-notch, multi-pass), or the like. In the illustrated embodiment, optic(s) 115 is/are located after homogenizer 112; however, optic(s) 115 may also be located between source 110 and homogenizer 112.

Referring to FIG. 2, in certain embodiments, an instrument or system 100′ comprises the same or similar optical elements as discussed for system 100, which are configured so that at least portions of an excitation optical path and an emission optical path are common to one another. In such embodiments, imaging and/or conditioning optics 115 may include one or more imaging and/or conditioning optics 115A located in the excitation optical path and/or one or more imaging and/or conditioning optics 115B located in both the excitation and emission optical paths. In the illustrated embodiment, optic(s) 115A is/are located after homogenizer 112; however, optic(s) 115 may also be located between source 110 and homogenizer 112. System 100 also comprises one or more mirrors, filters, or beamsplitters 125 that are common to both excitation and emission optical paths, for example, to selectively transmit and/or reflect radiation or light at one or more predetermined wavelengths or range of wavelengths. In the illustrated embodiment, beamsplitter 125 reflects excitation radiation or light and transmits emission radiation or light. In other embodiments, system 100′ is configure such that beamsplitter 125 transmits excitation radiation or light and reflects emission radiation or light. In certain embodiments, optical element(s) 115B comprises a lens or lens system that is telecentric or provides a telecentric optical system, for example, in which each sample of sample holder 118 is illuminated from the same direction or axis, or approximately the same direction or axis. Optics 115, 115A, 115B, or 120 may include one or more windows, refractive lenses, gratings, prisms, diffractive optical elements, mirrors, beamsplitters, filters, or the like, either alone or in combination. Filters may be located in an excitation beam path and/or the emission beam path, and may include neutral density filters, spectral filters (e.g., high pass, low pass, bandpass, notch, interference, dichroic, multi-notch, multi-pass), or the like.

Sample holder 118 comprises a substrate providing or containing a plurality of separate or distinct reaction sites or chambers. each of the sites or chambers may be configured to support one or more biological samples of interest, and may include associated reagents, markers, enzymes, dyes, primers, nucleotides, buffers, detergents, blocking agents, or the like. The reaction sites may be disposed on a surface of the substrate, located in wells or through holes, or may be disposed within the substrate, for example, in the form of distinct reaction chambers and/or located along one or more channels or capillaries located in or on the substrate. The reaction sites may be disposed within a one-dimensional, two dimensional, or three-dimensional array of reaction sites.

In certain embodiments, sample holder 118 may comprise a chip, such as an electronic chip. Additionally or alternatively, sample holder 118 may comprise a microfluidic device which, for example, may further include a plurality of channels or paths for transferring reagents and/or test solutions to some or all of the reaction sites. In other embodiments, the reaction sites of sample holder 118 comprise a plurality of droplets or beads and sample holder 118 may comprise one or more chambers and/or channels containing some or all of the droplets or beads. In such embodiments, the droplets or beads may form an emulsion, where some or all of the droplets or beads contain one or more target samples of at least one polynucleotide or nucleotide sequence, or some other biomolecule of interest. Where the reaction sites of sample holder 118 are beads, the beads may optionally include an attached optical signature or label. The droplets or beads may be inspected, monitored, or measured either one at time or in groups containing one or more droplets or beads, for example using an imaging system according to embodiments of the present invention.

In certain embodiment, sample holder 118 comprises a plurality of through-holes, for example, as disclosed in U.S. Pat. Nos. 6,306,578; 7,332,271; 7,604,983; 7,6825,65; 6,387,331; or 6,893,877, all of which are herein incorporated by reference in their entirety as if fully set forth herein. Other embodiments of sample holder 118 are disclosed in U.S. patent application Nos. 61/541,635; 61/541,495; 61/541,366; 61/612,087; 61/612,005; 61/612,008; or 61/659,029, all of which are herein incorporated by reference in their entirety as if fully set forth herein.

Sample holder 118 may comprise a substrate made of any of the various materials known in the fabrication arts including, but not limited to, a metal, glass, ceramic, silicon, or the like. Additionally or alternatively, the substrate may comprise a polymer material such as an acrylic, styrene, polyethylene, polycarbonate, and polypropylene material. The substrate and reaction sites may be formed by one or more of machining, injection molding, hot embossing, laser drilling, photolithography, or the like. In certain embodiments, the outer surfaces of the substrate comprise a hydrophobic material or coating, while the walls inside the substrate (e.g., through-hole, well, via, channels, or the like) comprise a hydrophilic material or coating. In such embodiments, samples may be maintained within a reaction chamber or volume by surface tension or capillary forces.

In certain embodiments, it has been discovered that systems 100, 100′, and/or homogenizer 112 have particular advantage in applications and system where very high sensitivity is desirable. For example, in qPCR systems and applications, it is desirable to detect relatively low signals during the early cycles of a PCR process in order to provide accurate estimations of the initial amount of one or more target poly nucleotides. In such circumstances, homogenizer 112 may be configured to prevent or reduce illumination non-uniformity, thereby mitigating or eliminating a situation in which excitation of sample sites or reaction regions at the edges of a sample array are so low that the signal-to-noise ratio at theses locations is too low to provide as specified sensitivity. For example, without homogenizer 112 it has been found that the background noise from scattered light or noise in the detector may be high enough and excitation low enough that sensitivity is lost. While it is possible to increase the intensity of the excitation source in such situations, this may lead to saturation or photobleaching in the highly illuminated area (e.g., for sample sites or reaction regions near the center of an array). Without homogenizer 112, undesirable spatial variations in sensitivity result.

Source 110 may comprise one or more light emitting diodes (LEDs), Arc Lamps, Halogen Lamps, Lasers, or the like. Source 110 may comprise one or more extended sources, for example, comprising a radiance area characterized by a diameter normal to an optical axis that is greater than or equal to 0.5 millimeter, greater than or equal to 1 millimeter, greater than or equal to 2 millimeter, or greater than or equal to 5 millimeter. In certain embodiments, source 110 comprises one or more extended sources having illumination properties that vary over an area or face of the source. For example, the intensity or power of source 110 may vary over an area or face (e.g., may be brighter or emit more power or intensity near a center of the source than at locations near or about a periphery of the source). Additionally or alternatively, source 110 may be characterized by a function of radiant intensity versus angle that varies over an area or face of the source. Additionally or alternatively, source 110 may be characterized by other optical properties that vary over an area or face of the source, for example, having a nominal wavelength or spectral function that varies over different portions of an area or face of the source.

In certain embodiments, systems 100 or 100′ may be compact, portable, and/or handheld system or instrument. For example, systems 100 or 100′ could comprise a compact, portable, or handheld instrument suitable for use in field, industrial, or laboratory environments, for example, for use in air or water testing, food inspection or safety, human or animal health screening or monitoring, doctor office testing or screening, or the like.

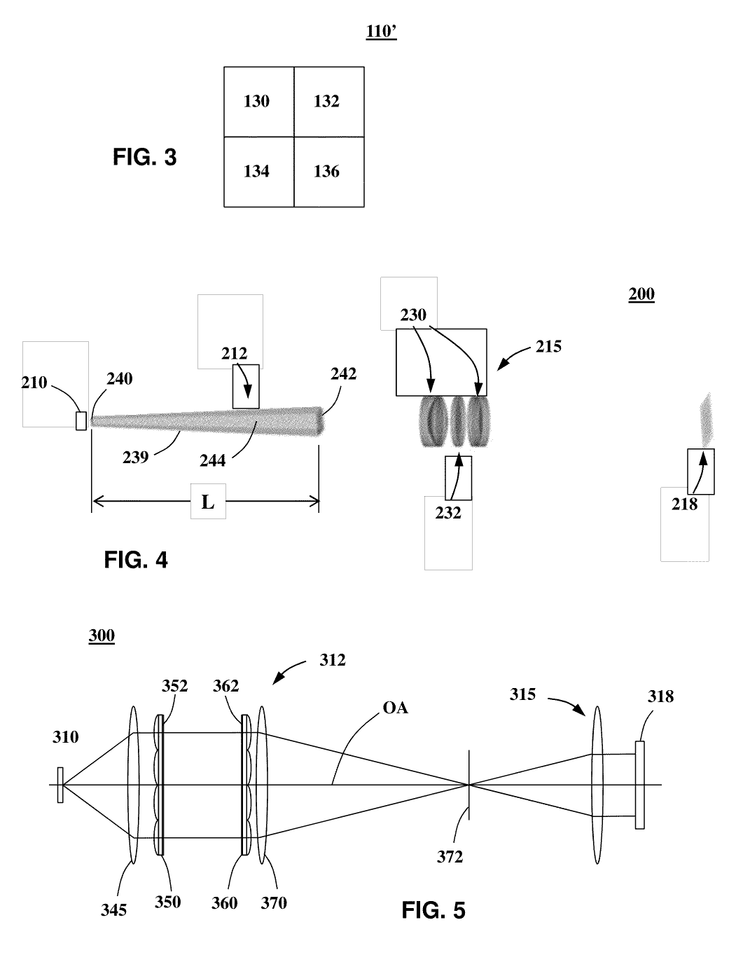

Referring to FIG. 3, in certain embodiments, source 110 may comprise a plurality of individual radiant or light sources 110′ (e.g., individual LED light sources), where one or more of the individual sources is characterized by a different color, nominal wavelength, and/or spectral band or function than at least some of the other individual sources. In the illustrated embodiment of FIG. 3, source 110 comprises four individual radiant sources 130, 132, 134, 136, where one or more of source 130, 132, 134, 136 is characterized by a different spectral characteristic than the other sources 130, 132, 134, 136. For example, source 130 may be a red LED, source 132 may be a green LED, source 134 may be a blue LED, and source 136 may be a white LED (e.g., emitting radiation over a continuous wavelength range from 440 nanometers to 680 nanometers or from 470 nanometers to 660 nanometers). Alternatively, one or more of the sources 130, 132, 134, 136 may be characterized by a central wavelength or wavelength band that is equal to or overlaps a central wavelength or wavelength band of a particular dye used in PCR or sequencing reaction, system, or instrument. In certain embodiments, one or more of sources 130, 132, 134, 136 may be characterized by a central wavelength or wavelength band that is equal to or overlaps a central wavelength or wavelength band of one or more of the following dyes: FAM™, ROX™, VIC®, SYBR®, SYTO®9, TAMRA™, NED™, MeltDoctor™, JOE™, TET™, HEX™, BODIPY®, TMR-X, Texas Red®, LIZ™, Alexa Fluor®, Joda-4, Mustang Purple™. In certain embodiments, one or more of sources 130, 132, 134, 136 may be characterized by a central wavelength or wavelength band that includes one or more of the following wavelengths: 470 nanometers, 520 nanometers, 550 nanometers, 580 nanometers, 640 nanometers, or 662 nanometers.

In certain embodiments, the plurality of sources 110′ comprises only two sources 130, 132 or three sources 130, 132, 134. Alternatively, plurality of sources 110′ comprises more than the four sources shown in FIG. 3, for example, five, six, ten, or more than ten sources.

In the illustrated embodiment shown in FIG. 3, individual sources 130, 132, 134, 136 are arranged adjacent to one another, for example, so as to form a square. Other arrangement of multiple radiant or light sources are anticipated, wherein a color or spectral characteristic varies over an area or face of source 110. For example, individual sources 130, 132, 134, 136 may each comprise an end of a fiber optic or a fiber optic bundle. In such embodiments, the fiber ends may be arrange in the geometry illustrated in FIG. 4, or may be otherwise arranged (e.g., arranged so that the plurality 110′ is circular). In certain embodiments, individual sources 130, 132, 134, 136 may be arranged so that some or all of the individual sources are concentric with one another (e.g., wherein individual sources 130, 132, 134, 136 form a set of concentric circle). In certain embodiments, at least one of the individual sources 130, 132, 134, 136 is physically located apart from one or more of the other individual sources 130, 132, 134, 136, wherein an imaging system is used to produce an image of the source that is located proximal the remaining sources 130, 132, 134, 136 and/or images of the remaining sources 130, 132, 134, 136.

In certain embodiments, radiant energy or light from source 110 is characterized by a constant or optical invariance that is equal to a product of an area of the source and a solid angle of source radiation, or equal to a product of a dimension of the source and an angle, or the sine of an angle, of source radiation. In this regard, radiant source 110 may have a relatively large angel of radiation (e.g., a half angle of radiation that is greater than or equal to 45 degree, 60 degrees, or 75 degrees).

The design of homogenizer 112 and conditioning optics 115 may be guided by various laws of physics and optics. For example, the concept of a system “optical invariant” may be used to guide the design, wherein the product of area and the solid angle of radiation are constant throughout the optical system. In one dimension, this may be expressed as the product of the length and the sin (half angle) of radiation. For example, if a 2 millimeter square source radiating out to 45 degrees half angle is expanded to 4 mm square, then the angular extent is reduced according to the relationship:

$${θ}_{2} = {sin}^{- 1} \frac{{h}_{1} sin {θ}_{1}}{{h}_{2}} .$$

In this example, the output would be 4 millimeters square and the half angle of output would be 20.7 degrees.

In certain embodiment, it may be useful to design the entrance and exit faces of homogenizer to reduce the angular extent of radiation in order that this radiation can be more efficiently coupled into the projection optics. This has the added benefit of allowing projection optics of less power to be used.

Referring to FIG. 4, in certain embodiments, an instrument or system 200 comprises a radiant or light source 210, a homogenizer 212, imaging and/or conditioning optics 215, and a sample holder 218 comprising a plurality of distinct or spatially separated biological or biochemical samples. Conditioning optics 215 may comprise a pair or system of lenses or lens elements 230. Conditioning optics 215 may also include a spectral filter 232. Spectral filter 232 may be a single filter or filter module, or may be one of a set of filters (not shown), such as a filter wheel, that is selected to provide a predetermined spectral characteristic for an excitation illuminating sample holder 218.

Homogenizer 212 comprises an elongated body 239 that includes an input face or end 240 that faces toward source 110, an output face or end 242 that faces toward conditioning optics 215, and one or more side walls between faces 240, 242. Homogenizer 212 has a length, L, that is greater that the largest diameter of either input face 240 or output face 242. For example, the ratio of length, L, of homogenizer 212 to the largest diameter of either input face 240 or output face 242 may be greater than or equal to 4, greater than or equal to 10, greater than or equal to 20, or greater than or equal to 100. The divergence angle of radiation from source 210 collected by homogenizer 212 may be decreased at output face 242 by configuring the area of output face 242 to be larger than the area of input face 240. Homogenizer body 239 is made of a transparent material, or nearly transparent material, such as glass, plastic, fused silica, or the like. Side walls 244 may be optically smooth (e.g., having a roughness that is less than the wavelength of radiation to be used to excite a fluorescent dye or probe), for example, to avoid or reduce scattering or loss of radiation from source 210 as it is reflected off side walls 244. Side walls 244 may be straight between faces 240, 242 or arcuate in shape, for example, parabolic, hyperbolic, or the like. Faces 240, 242 may be flat or curved. The transverse shape of faces 240, 242 may be round, elliptical, square, rectangular, hexagonal, or the like. The shape and/or surface profile of output face 242 may be the same as that of input face 240. Alternatively, the shape and/or surface profile of output face 242 may be different than that of input face 240. The area of output face 242 may be the same as, larger, or smaller than the area of input face 240. The divergence angle of radiation from source 210 collected by homogenizer 212 may be decreased at output face 242 by configuring the area of output face 242 to be larger than the area of input face 240.

Homogenizer 212 may be configured to alter the spatial and angular characteristics present at the input face 240 into a more uniform beam as it exits output face 242. Conditioning optics 215 may be configured to project output face 242 in space onto a plane containing the samples of sample holder 218. Projection may be accomplished using one or more lenses, but is not restricted to this method. The projection may be configured to preserve uniform illumination, but may be configured to create a different size, smaller or larger (magnification).

In the illustrated embodiment, conditioning optics 215 are configured to provide an image of output face 242 of homogenizer 212 on or near a face of sample holder 218. According to embodiments of the present invention, this may be done efficiently, with little or no reduction in image quality. Conditioning optics 215 or 115 may consist of a singlet lens, but higher efficiency and a better quality image may be provided using the pair of lenses 230 shown in FIG. 4, for example, arranged with the most curved surfaces facing each other and the flatter surfaces facing outwardly toward homogenizer 212 and sample holder 218, respectively. Lenses 230 may be plano-convex, achromatic, or aspheric, or combinations thereof. Size changes can be accomplished by appropriate use of lenses with different or unequal focal lengths. For example, for 1:2 imaging (e.g., from 4 millimeter to 8 millimeter) a 25 millimeter focal length lens could be used to collect radiation from homogenizer output face 242, followed by a 50 millimeter focal length lens to image homogenizer output face 242 onto or near the samples of sample holder 218.

In certain embodiments, source 210 comprises a plurality of individual radiant or light sources characterized by radiation having different colors or different central wavelengths, for example, comprising the plurality of four sources 130, 132, 134, 136 discussed above in relation to FIG. 3. Homogenizer 212 may be configured to provide an excitation beam and/or radiation at sample holder 118 comprising a mixture of radiation from each of the four sources 130, 132, 134, 136. Alternatively, source 210 may comprise a plurality of individual sources that is less than four individual sources (e.g., two or three) or greater than four individual sources (e.g., five, six, ten, or more than ten sources). In such embodiments, all or a plurality of the samples of sample holder 218 are illuminated by radiation or light having the same or about the same intensity and/or spectral content. For example, the variation in illumination intensity or flux of radiation between all or a plurality of the samples of sample array may be less than 20 percent, less than 10 percent, less than 5 percent, or less than 1 percent. Additionally or alternatively, the variation in illumination intensity or flux of radiation at a predetermined wavelength, or over a predetermined wavelength band, between all or a plurality of the samples of sample array may be less than 20 percent, less than 10 percent, less than 5 percent, or less than 1 percent. The predetermined wavelength band in such embodiments may be 460 nanometers to 480 nanometers, 510 nanometers to 530 nanometers, 540 nanometers to 560 nanometers, 570 nanometers to 590 nanometers, 630 nanometers to 650 nanometers, or 652 nanometers to 672 nanometers.

The mixture of radiation received by the samples of sample holder 118 may be characterized by a spectral distribution of excitation radiation to sample holder 118 that is uniform over all or some of the samples contained in sample holder 118. For example, the spectral distribution of radiation provided by homogenizer 212 may be characterized by an excitation radiation received by some or all of the samples having an intensity or power variation at one or more wavelengths or colors that is less than or equal to 50 percent, less than or equal to 10 percent, less than or equal to 3 percent, and/or less than or equal to 1 percent.

It has been discovered that the use of a plural individual radiant or light sources, in combination with a homogenizer according to embodiments of the present invention, advantageously provide an excitation beam to an array or plurality of samples having a favorable and/or selectable spectrum and to a larger array of samples than that provided by prior art systems or instruments. The combination of these components may be configured to provide an excitation beam characterized by a spectral content or function that simultaneously illuminates multiple dyes in a plurality of samples or reaction sites, such that the emission level from each dye is at or above a predetermined level. For example, an excitation beam may be provided that is characterized by a spectral content or function configured so that two or more dyes provide an emission signal that is detectable over a large number of reaction sites, and/or in which the signals from the two or more dyes are all above a predetermined threshold. Thus, system 200 may be configured to provide an excitation beam to a plurality of reaction sites that is customizable for a particular set of dyes or sample conditions.

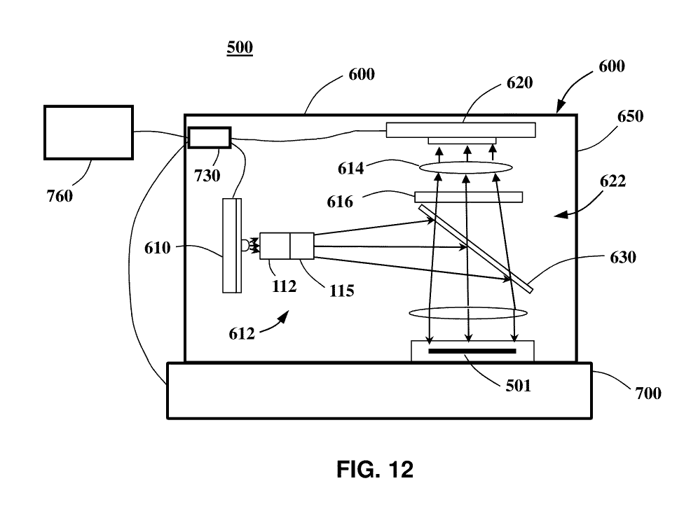

In certain embodiments, system 200 comprises a computer or processor (e.g., like computers 730 or 760 discussed in reference to FIG. 12) that controls a plurality of individual radiant or light sources of source 210, wherein two or more individual sources are characterized by radiation having a color or central wavelength that are different, the one from the other. The computer or processor is configured so that the resultant excitation beam spectrum provided by source 210 may be changed, for example, depending on the dyes contained in one or more of the samples of sample holder 218 or depending on the amount of one or more target biochemical (e.g., target nucleotides) contained in one or more of the samples of sample holder 218.

When possible, embodiments of system 200 may incorporate any of the elements, features, and/or configurations of systems 100 and/or 100′, and vice versa.

Referring to FIGS. 5, in certain embodiments, a system 300 comprises an optical axis OA, a radiant or light source 310, a homogenizer 312, imaging and/or conditioning optics 315, and a sample holder 318 comprising a plurality of distinct or spatially separated reaction sites or biological samples. Homogenizer 312 may comprise an input lens 345, a first lenslet array 350 including a first plurality of lens elements 352, a second lenslet array 360 including a second plurality of lens elements 362, an output lens 370, and an output plane 372. Each of input lens 345, lens elements 352, lens elements 362, and output lens 370 may comprise one or more refractive lenses (e.g., simple lens, compound lens, achromat lens, camera lens, or the like). Additionally or alternatively, one or more of elements 345, 352, 362, or 370 may comprise a minor, diffractive grating or optical element, or the like.

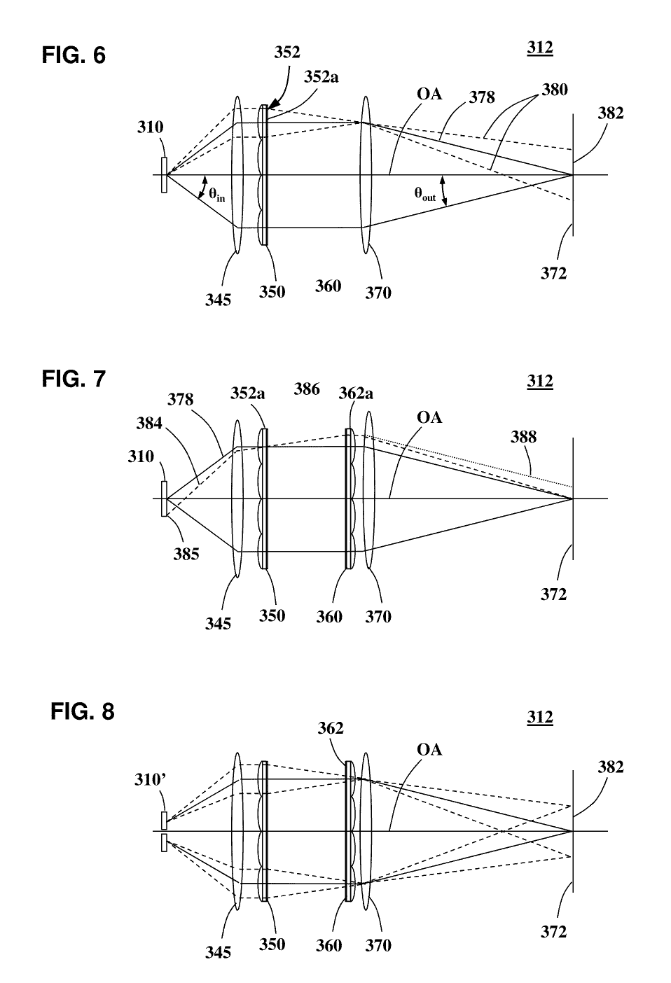

The construction and function of homogenizer 312 may be explained with additional reference to FIGS. 6-7. Referring to FIG. 6, the optical path of radiation from a center of source 310 through homogenizer 312 is now explained. For simplicity of explanation, second lenslet array 360 is not included in FIG. 6. A central ray 378 propagates from the center of source 310, is collected by input lens 345 and is directed through the center of lens 352a of first lenslet array 350, and then refracted by output lens 370 to optical OA at the center of outlet plane 372. Peripheral rays 380 from the same central location of source 310 are also collected by input lens 345, propagate parallel to ray 378, and are then focused by lens 352 to intersect ray 378 at lens 370. Lens 370 also refracts rays 380 to define an outer periphery of an illumination area 382 at output plane 372. Thus, radiation or light from the central location of source 310 passing through lens 352a fills the illumination area 382. In similar manner, radiation or light from the center of source 310 that passes through the other lenses 352 of first lenslet array 350 also fills the illumination same area 382 at output plane 372. Thus, homogenizer 312 serves to reduce variations of intensity with angle from source 310, for example, by collecting radiation emitted by source 310 at different angles (e.g., through different lenses 352 of first lenslet array 350) and redirecting the radiation through corresponding lens 352 to overlap and generally fill the same illumination area 382 at output plane 372. In addition, inspection of FIG. 6 shows that the NA of the radiation collected by homogenizer 312 is reduced by approximately the ratio to θ_{out/θ}ᵢₙ.

Referring now to FIG. 7, a function of lenslet array 360 for radiation or light from other portions of extended source 310 is now provided. The optical path of central ray 378, which was discussed in reference to FIG. 6 and which passes through the center of lens 352a, is reproduced again in FIG. 7 for reference. A central ray 384 from a location 385 at or near the bottom of extended source 310 also passing through the center of lens 352a (dashed line in FIG. 7). Because central ray 384 enters lens 352a at an angle, it arrives at lenses 362a, 370 at a location 386 that is above ray 378 and is also angled up and to the right, relative to central ray 378. If lenslet array 360 were not present, ray 384 would follow the path indicated by dotted line 388 in FIG. 7 and be located above optical axis OA at output plane 372. Thus, radiation from extended source 310 emitted from location 385 would not completely overlap radiation from the center of extended source 310. However, with the inclusion of second lenslet array 360, the lens 362a bends radiation from bottom location 385, on average, more that it bends radiation from the center of extended source 310. Thus, the optical power of lens 362a may be selected so that radiation from bottom location 385 overlaps, or nearly overlaps, radiation from the center of extended source 310. In similar fashion, second lenslet array 360 may be configured so that radiation from all locations on extended source 310 also overlap, or nearly overlap, radiation from the center of extended source 310. Thus, homogenizer 312 may be configured so that radiation or light emitted from an extended source 310 at different angles, and from different locations on the extended source, all overlap, or nearly overlap, a common illumination area 382 at output plane 372.

Advantageously, the homogenization and reduction in NA of source 310 provided by homogenizer 312 provides both more power, energy, irradiance, or intensity to the samples in sample holder 318, in addition to more even illumination between samples (e.g., as discussed above in relation to the system shown in FIG. 4).

Referring to FIG. 8, system 300 may comprise a plurality of individual radiant or light sources 310′ having different colors or central wavelength from one another. Plurality of individual sources 310′ may comprise the plurality 110′ of individual radiant or light sources discussed in relation to FIG. 3. As illustrated in FIG. 8, homogenizer 312 may be configured so that the different colors of the plurality of individual radiant or light sources 310′ all overlap, or nearly overlap, over common illumination area 382 at output plane 372.

When possible, embodiments of system 300 may incorporate any of the elements, features, and/or configurations of systems 100, 100′ and/or 200, and vice versa. Referring to FIG. 12, a system 500 may be used to optically view, inspect, or measure one or more samples or solutions containing biological components of interest that are located in reaction sites of a sample holder 501. System 500 comprises an optical head or system 600 configured to read or monitor some or all of the reaction sites of sample holder 501. In certain embodiments, system 500 may further include one or more of a thermal control system 700, an integrated controller, computer, or processor 730 located on or within the optical head 600 and/or thermal control system 700, and/or an external controller, computer, or processor 760 located external to optical head 600 and thermal control system 700.

Either or both computers 730, 760 may include electronic memory storage containing instructions, routines, algorithms, test and/or configuration parameter, test or experimental data, or the like. Either or both computers 730, 760 may be configured, for example, to operate various components of optical system 600 or to obtain and/or process data provided by system 500. For example, either or both computers 730, 760 may be used to obtain and/or process optical data provided by one or more photodetectors of optical system 600. In certain embodiments, integrated computer 730 may communicate with external computer 760 and/or transmit data to external computer 760 for further processing, for example, using a hardwire connection, a local area network, an internet connection, cloud computing system, or the like. External computer 760 may be physical computer, such as a desktop computer, laptop computer, notepad computer, tablet computer, or the like. Additionally or alternatively, either or both computers 730, 760 may comprise a virtual device or system such as a cloud computing or storage system. Data may be transferred or shared between computers 730, 760 via a wireless connection within a local area network, a cloud storage or computing system, or the like. Additionally or alternatively, data from system 500 (e.g., from optical system 600 and/or thermal controller 700) may be transferred to an external memory storage device, for example, an external hard drive, a USB memory module, a cloud storage system, or the like. System 500 may include both computers 730, 760. Alternatively, system 500 may include only one of either computer 730 or computer 760. In such embodiments, data from computer 730 or computer 760 may be stored, transferred, or processed via a hardwire connection, a local area network, an internet connection, cloud computing system, or the like.

In certain embodiments, optical system 600 comprises a radiant or light source 610 and an associated excitation optic system 612 configured to illuminate at least some of samples contained in the reaction sites of sample holder 501. Excitation optical system 612 may include one or more lenses and/or one or more filters (not shown) for conditioning light directed to the samples. Optical system 600 may further comprise a photodetector or optical sensor 620 and an associated emissions optical system or imaging system 622 configured to receive radiation emitted by at least some of the reaction sites and direct this radiation onto optical sensor 620, for example, by forming an image of sample holder 501 or the associated reaction sites at or near optical sensor 620. Radiation received by the emissions optical system may be fluorescence produced within the reaction sites in response to one or more excitation beams produced by source 610. For example, when system 500 is configured to perform a qPCR and/or a dPCR procedure or process, the reaction sites may contain fluorescent dyes that provide a fluorescent signal that varies according to an amount of a target nucleotide sequence or molecule contained in various of the reaction sites of sample holder 501. Emissions optical system 622 may include one or more lenses 624 and/or one or more filters 616 for conditioning light directed to the samples.

In the illustrated embodiment shown in FIG. 12, excitation/emissions optical systems 612, 622 both comprise one or more common optical elements. For example, excitation/emissions optical systems 612, 622 may both comprise a beamsplitter, minor, or filter 630 that reflects excitation light and transmits emission light from the samples to photodetector 620. In certain embodiments, excitation/emissions optical systems 612, 622 both comprise a field lens (not shown) disposed between beamsplitter 630 and sample holder 501, which may be used improve optical performance, for example, by providing even illumination and/or emission of light to and from the reaction sites. In certain embodiments, for example where even illumination or emission is less critical (e.g., some dPCR applications), the common field lens may be omitted, as shown in the illustrated embodiment of FIG. 12. Omission of the field lens may help to reduce the size and complexity of optical system 600. Exemplary embodiments of excitation and emission optical systems are discussed in U.S. Pat. Nos. 6,818,437; 7,498,164; 7,387,891; 7,635,588; or 7,410,793, which publications are herein incorporated by reference in their entirety.

Optical system 600 also compromises homogenizer 112 and/or imaging or conditioning optic(s) 115, as discussed above in relation to FIG. 2. Optic(s) 115 shown in FIG. 12 may include one or more windows, refractive lenses, gratings, prisms, diffractive optical elements, minors, beamsplitters, filters, or the like, either alone or in combination. Filters may be located in an excitation beam path and may include neutral density filters, spectral filters (e.g., high pass, low pass, bandpass, notch, interference, dichroic, multi-notch, multi-pass), or the like. In the illustrated embodiment, optic(s) 115 is/are located after homogenizer 112; however, optic(s) 115 may also be located between source 610 and homogenizer 112. In the illustrated embodiment, beamsplitter 630 reflects excitation radiation or light and transmits emission radiation or light; however, system 500 may alternatively be configured such that beamsplitter 630 transmits excitation radiation or light and reflects emission radiation or light. When possible, optical system 600 may incorporate any of the elements, features, and/or configurations of systems 100, 100′, 200, and/or 300 and vice versa.

Photodetector 620 may comprise one or more photodiodes, photomultiplier tubes (PMTs), or the like. Such photodetectors may be used, for example, where optical system 600 is configured to scan individual the reaction sites or subsets of the reaction sites. In other embodiments, photodetector 620 may comprise one or segmented detector arrays, for example, one or more CCD (charge coupled device) or CMOS (complementary metal-oxide semiconductor) arrays. Segmented detector arrays may be advantageously used where all or large groups of the reaction sites are simultaneously imaged or inspected. In order to provide a plurality of pixels per each reaction site, photodetector 620 may comprise at least 4,000,000 pixel or more than 10,000,000 pixels.

Any or all of the components or elements of optical head 600 may be mounted to one or more common frames (not shown). In certain embodiments, any or all of the components or elements of optical head 600 may be enclosed within a housing or case 650, for example, to prevent or reduce the introduction of external or stray light, to protect optical head 600 from external dust and debris, and/or to shield from electrical or magnetic noise. In the illustrated embodiment of FIG. 12, source 610 and photodetector 620 are contained within housing 650. Alternatively, source 610 and/or photodetector 620 may be mounted on an external surface of housing 650 and/or may be partially located within housing 650.

In certain embodiments, optical system 400 is configured to provide simultaneous imaging of a large number reaction sites of sample holder 301, for example, a sufficiently large number of reaction sites to provide a dPCR analysis of one or more target molecules, sequence, genes, biological micro-organisms, or the like. For example, system 600 may be configured to simultaneously image at least 20,000 reaction sites, wherein a density of reaction sites may be at least 100 reaction sites per square millimeter and/or each reaction site may have a characteristic diameter that is less than or equal to 100 micrometers. For example, an example embodiment of the instant invention (herein referred to as Example A), a two-dimensional array of 29,760 reaction sites, each having a characteristic diameter of less than 70 micrometers, were simultaneously imaged and processed to provide a dPCR analysis of a target nucleotide sequence or molecule. In the Example A embodiment, reaction sites were arranged in a 160×186, hexagonally arrange pattern (like that shown in FIG. 6 or 13) over active area of sample holder 501 that was less than 14 millimeters by about 14 millimeters (about 13 millimeters by about 13 millimeters). The reaction volume of each reaction site may be less than one nanoliter. In other embodiments, the active area of sample holder 501 comprises at least 25,000 reaction sites, at least 30,000 reaction sites, at least 100,000 reaction sites, or at least 1,000,000 reaction sites.

### EXAMPLE

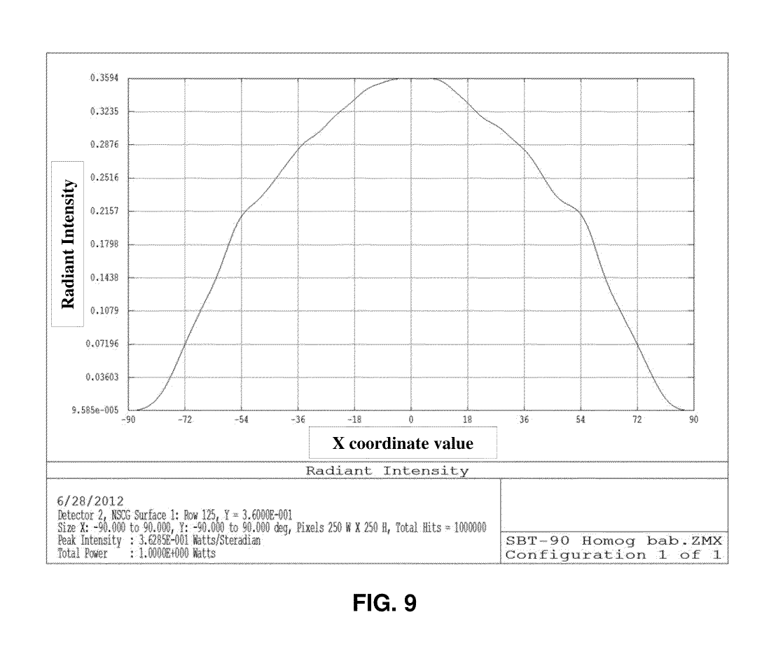

Referring again to FIG. 4, a system according to an embodiment of the present invention was modeled. The system model included a high power white LED light source 210 that was configured to produce a uniformly illuminated sample region of 20 millimeters by 20 millimeters. Light source 210 comprised the optical characteristics of a Luminus CBT-90 LED (1), which emits a broad spectrum of light from 400-700 nm, is 3 millimeter by 3 millimeter square, and emits light into a full hemisphere with an angular pattern as shown in FIG. 9.

The system model further included conditioning optics 215, which imaged output face 242 onto or near a face of sample holder 218. Optical bandpass filter 232 was located between lenses 230 in a nearly collimated optical path. This location avoids angular shift in the bandpass of the optical filter. From left to right in FIG. 4, lenses 230 had focal lengths of 50 mm and 100 mm, respectively. This provided a predetermined magnification of output face 242 of homogenizer 212 of 2 (ratio of the focal length of the second lens to the focal length of the first lens). Use of a pair lenses 230 was used instead of a single lens to takes advantage of the speed of the lenses (e.g., low f-number (f#) or high Numerical Aperture (NA), which indicates increasing ability of the lenses to gather radiation from a radiant or light source that is radiating an angular distribution of light). The speed of the lenses 230, especially the first lens nearest output face 242, were selected to be equal to or higher than that of the output face of the homogenizer 212.

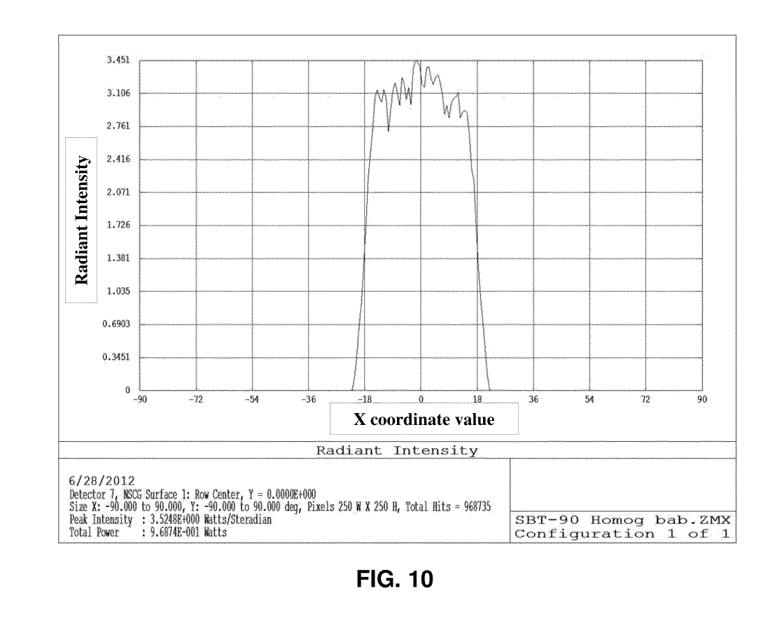

The system model further included homogenizer 212, comprising a glass material (BK7) in the form of a tapered concentrator rod that was 100 millimeters in length. Homogenizer 212 may alternatively comprise other materials such as a polymeric material (e.g., acrylic, plastic), fused silica, or the like. The transverse or cross-sectional size of the rod increased in diameter or area from input face 240 to output face 242 to transform the wide angular output of the LED shown in FIG. 9 to a narrower angular output as shown in FIG. 10. Alternatively, the transverse or cross-sectional size of the rod may decrease. The size of the entrance face of the concentrator in the system model was selected to collect a large spatial and angular extent or output of the LED. The input face 240 was 4 millimeters by 4 millimeters and an output face 242 was 12 millimeters by 12 millimeters. The shape and size of faces 240, 242 may be other shape and/or sizes as desired for a particular application or system specification. For example, either or both faces 240, 242 may have a shape that is triangular, circular, elliptical, polygonal (e.g., hexagonal), or the like. In certain embodiments, input face 240 and output face 242 have different shapes from one another (e.g., input face 240 may be circular to increase collection efficiency from a radiant or light source, while output face 242 may be square or rectangular to match the shape of sample holder 118.

From FIG. 10, the NA for the 12×12 mm output was 0.30 (sin (18°); f#=1.6). Lens 230 closest to output face 242 had a focal length of 50 millimeters and a diameter of 25 millimeter, giving an f# of 2.0. Thus, conditioning optics 215 were slightly optically slower than homogenizer 212, so that some radiation was not collected from homogenizer 212. Some losses may also be incurred because the 12 mm square size of the homogenizer output face is appreciable compared to the size of the first lens 230 (i.e., lens nearest output face 230). Some of the radiation emerging from a corner of the homogenizer at f/1.6 was not collected by lens 230. In other embodiments, this may be corrected by use of a faster first lens. Custom lenses may alternatively be used for better speed matching.

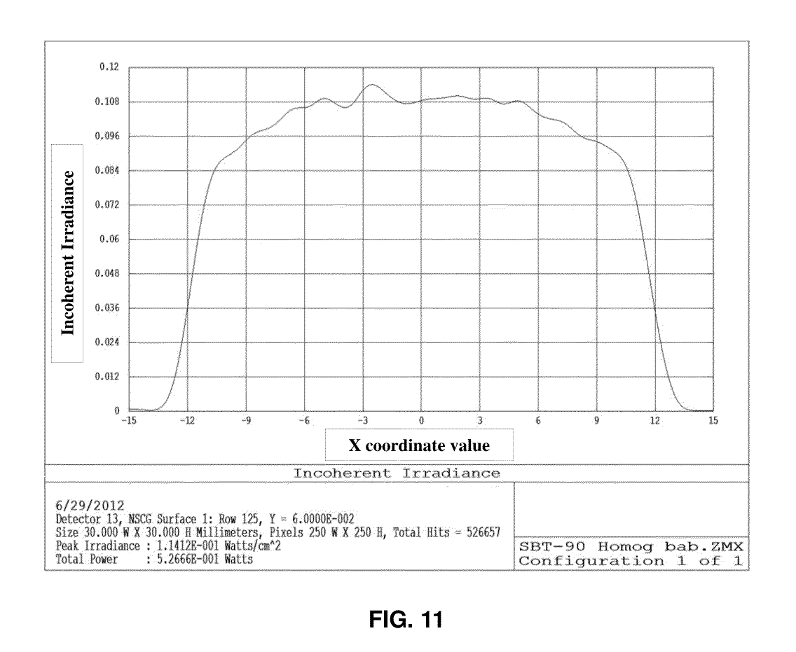

FIG. 11 shows a profile of the illumination at a sample plane at or near sample holder 218. The efficiency in a 20 millimeter by 20 millimeter area in this plane was at least 40% of the total output of LED source 210. The uniformity over this 20 millimeter by 20 millimeter area was less than or equal to ±5%. In other embodiments, efficiency of at least 50% is obtained by increasing the length of the homogenizer 212 to create a more uniform illumination and then reducing the magnification a small amount.

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover modifications and alternate constructions coming within the spirit and scope of the invention as generally expressed by the following claims, which particularly point out and distinctly claim the subject matter of the invention.

What is claimed is:

1. A system for detecting emissions from a sample containing nucleotide molecules, comprising:
a sample holder comprising a plurality of spatially separated reaction sites configured to hold a sample containing nucleotide molecules;
an optical illumination system comprising a radiant source configured to simultaneously illuminate two or more of the reaction sites, the illumination system comprising a homogenizer;
an optical sensor comprising a plurality of pixels;
wherein an output from the homogenizer has less variation in power, energy, irradiance, or intensity than the variation in power, energy, irradiance, or intensity of the source.

2. A system for detecting emissions from a sample containing nucleotide molecules, comprising:
a sample holder comprising a plurality of spatially separated reaction sites configured to hold a sample containing nucleotide molecules;
an optical illumination system comprising a light source configured to simultaneously illuminate two or more of the reaction sites, the illumination system comprising a homogenizer;
an optical sensor comprising a plurality of pixels;
wherein the homogenizer reduces a variation of intensity of radiation from the light source received by the two or more reaction sites.

3. The system according to any one of claim 1, 2, 15, or 16, wherein the homogenizer comprises an elongated body including an input end configure to receive an excitation beam from the source and an output end configured to illuminate the two or more reaction sites.

4. The system of claim 3, wherein the area of the output end is larger than the area of the input end.

5. The system of claim 3, wherein the homogenizer has a length that is greater that a maximum diameter of the input end and is greater that a maximum diameter of the output end.

6. The system of claim 3, wherein the homogenizer comprises a bundle of fiber optics, each fiber of the bundle comprising an input face located at the input end and an output face located at the output end.

7. The system of claim 3, wherein the homogenizer comprises a bundle of fiber optics, each fiber of the bundle comprising an input face located at the input end and an output face located at the output end, wherein the order of the output faces is different than the order of the input faces.

8. The system according to any one of claim 1, 2, 15, or 16, wherein the homogenizer comprises a first lenslet array configured to receive an excitation beam from the source and a second lenslet array is configured to receive radiation from the excitation beam that passes through the first lenslet array.

9. The system according to any one of claim 1, 2, 15, or 16, wherein the source comprises a plurality of individual sources and at least one of the individual sources comprises a spectral function that is different than a spectral function of at least one of the remaining individual sources.

10. The system of claim 9, wherein each spectral function is characterized by a band of wavelengths having an output above a predetermined minimum, wherein a minimum wavelength in band of wavelengths for the at least one of the individual source is different than a minimum wavelength in band of wavelengths for at least one of the remaining individual sources.

11. The system of claim 9, wherein each spectral function is characterized by a band of wavelengths having an output above a predetermined minimum, wherein a maximum wavelength in band of wavelengths for the at least one of the individual source is different than a maximum wavelength in band of wavelengths for at least one of the remaining individual sources.

12. The system according to any one of claim 1, 2, 15, or 16, wherein the source comprises a plurality of individual sources and at least one of the individual sources comprises a spectral function that is different than the spectral function of at least one of the remaining individual sources, wherein radiation from each of the individual sources fill a common area of an output face of the homogenizer.

13. The system of claim 12, wherein each spectral function is characterized by a band of wavelengths having an output above a predetermined minimum, wherein a minimum wavelength in band of wavelengths for the at least one of the individual source is different than a minimum wavelength in band of wavelengths for at least one of the remaining individual sources.

14. The system of claim 12, wherein each spectral function is characterized by a band of wavelengths having an output above a predetermined minimum, wherein a maximum wavelength in band of wavelengths for the at least one of the individual source is different than a maximum wavelength in band of wavelengths for at least one of the remaining individual sources.

15. A system for detecting emissions from a sample containing nucleotide molecules, comprising:
a sample holder comprising a plurality of spatially separated reaction sites configured to hold a sample containing nucleotide molecules;
an optical illumination system comprising a radiant source configured to simultaneously illuminate two or more of the reaction sites, the illumination system comprising a homogenizer;
an optical sensor comprising a plurality of pixels;
wherein an angular output of the homogenizer is less that an angular output of the source.

16. A system for detecting emissions from a sample containing nucleotide molecules, comprising:
a sample holder comprising a plurality of spatially separated reaction sites configured to hold a sample containing nucleotide molecules;
an optical illumination system comprising a radiant source configured to simultaneously illuminate two or more of the reaction sites, the illumination system comprising a homogenizer;
an optical sensor comprising a plurality of pixels;
wherein a variation of intensity of radiation from the light radiant source received by the two or more reaction sites is less than 10 percent.
